(19) United States
(12) Patent Application Publication
(10) Pub. No.: US 2025/0214106 A1
(43) Pub. Date: Jul. 3, 2025

(54) INK-REPELLENT MEMBER, METHOD OF PRODUCING INK-REPELLENT MEMBER, INK JET HEAD, AND METHOD OF PRODUCING ARTICLE

(71) Applicant: CANON KABUSHIKI KAISHA, Tokyo (JP)

(72) Inventors: YOHEI MIYAUCHI, Tokyo (JP); TADAHIRO MIMURA, Kanagawa (JP); JUNRI ISHIKURA, Tokyo (JP); KOJI SASAKI, Chiba (JP)

(21) Appl. No.: 18/982,036

(22) Filed: Dec. 16, 2024

(30) Foreign Application Priority Data
Dec. 27, 2023 (JP) 2023-221727

(51) Int. Cl. B05D 5/08; B05D 3/14; B41J 2/14; B41J 2/165; B41J 3/407

(52) U.S. Cl. CPC B05D 5/083; B05D 3/142; B41J 2/16502; B41J 3/407; B05D 2506/10; B41J 2/1433; B41J 2202/03

(57) ABSTRACT

Provided is an ink-repellent member including an underlying portion that contains a tantalum oxide, and has a fluorine compound bonded to a surface of the underlying portion via a Ta—O—Si bond, wherein, when a ratio of a fluorine atom amount with respect to a total of a carbon atom amount, an oxygen atom amount, the fluorine atom amount, a silicon atom amount, and a tantalum atom amount in measurement by X-ray photoelectron spectroscopy of the surface after the ink-repellent member is subjected to an immersion treatment (1) and (2) is represented by F, the F is 50 atm % or more.

### BACKGROUND OF THE INVENTION

### Field of the Invention

The present invention relates to an ink-repellent member and an ink jet head.

### Description of the Related Art

As a device that ejects an ink (hereinafter referred to as “ink jet head”), there have been known a bubble jet (trademark) head that instantaneously vaporizes an ink through use of a heater to fly liquid droplets, a piezo jet head that propels liquid droplets through use of a piezoelectric element, and the like. In order to record a high-quality image through use of an ink jet head, it is required that ink droplets be ejected from ink ejection orifices while their straightness is kept along a predetermined direction. However, when a liquid droplet residue adheres to an orifice plate surface on the periphery of the ejection orifices, ink droplets are dragged by the residue at the time of ejection of the ink droplets to cause deflection in an ejection direction, with the result that the ink droplets may fly out of the predetermined direction. In order to suppress the adhesion of the liquid droplet residue on the periphery of the ink ejection orifices, an ink-repellent film is formed on the periphery of the ink ejection orifices to provide an ink-repellent member.

For example, in Japanese Patent Application Laid-Open No. 2014-124879, there is disclosed that an underlying portion formed of an inorganic oxide is formed on an orifice plate surface, and a fluorine-containing silane coupling agent (hereinafter sometimes referred to as “fluorine compound”) is chemically bonded thereto to form an ink-repellent member.

In addition, in an ink jet head, in order to remove a liquid droplet residue, paper dust, and the like, the orifice plate surface is generally cleaned with a wiper or the like. Thus, the ink-repellent member is required to have ink resistance and sliding resistance.

### SUMMARY OF THE INVENTION

According to one aspect of the present invention, there is provided an ink-repellent member including an underlying portion that contains a tantalum oxide, and has a fluorine compound bonded to a surface of the underlying portion via a Ta—O—Si bond, wherein, when a ratio of a fluorine atom amount with respect to a total of a carbon atom amount, an oxygen atom amount, the fluorine atom amount, a silicon atom amount, and a tantalum atom amount in measurement by X-ray photoelectron spectroscopy of the surface after the ink-repellent member is subjected to the following immersion treatment (1) and (2) is represented by F, the F is 50 atm % or more:

### (Immersion Treatment)

(1) a test piece including the surface is cut out of the ink-repellent member, is placed in a sealable container containing a fluorine solvent containing a hydrofluoroether having a boiling point of 60° C. or more, and is immersed in the fluorine solvent so that the test piece is entirely immersed therein; and
(2) the test piece is maintained at 60° C. for 4 hours in a sealed state after the immersion in (1).

In addition, according to one aspect of the present invention, there is provided an ink-repellent member including an underlying portion that contains a tantalum oxide, and has a fluorine compound bonded to a surface of the underlying portion via a Ta—O—Si bond, wherein the surface has a root-mean-square slope (Rdq) of 0.08 or less.

In addition, according to one aspect of the present invention, there is provided a method of producing an ink-repellent member including an underlying portion containing a tantalum oxide, the underlying portion having a fluorine compound bonded to a surface thereof via a Ta—O—Si bond, the method including the following steps (1) and (2):
(1) subjecting the surface of the underlying portion to plasma treatment under an atmosphere having an oxygen concentration of 50 vol % or more; and
(2) applying a fluorine compound having a reactive silyl group represented by the following formula (1) onto the surface of the underlying portion subjected to the plasma treatment in the step (1), followed by dehydration condensation:

s*-Si(Y¹)ₙ(OR)ₘ (1)

in the formula (1), “n” and “m” each represent an integer of from 0 to 3 and n+m=3 is satisfied, Y¹s each independently represent an alkyl group, a chloro group, or a bromo group, Rs each independently represent a hydrogen atom or an alkyl group, and “*” represents a bonding position in the fluorine compound.

In addition, according to one aspect of the present invention, there is provided an ink jet head including the above-mentioned ink-repellent member. In addition, according to another aspect of the present invention, there is provided a method of producing an article including ejecting a liquid through use of the above-mentioned ink jet head, wherein the liquid is an ink containing a functional material for forming a functional thin film or a functional element.

Further features of the present invention will become apparent from the following description of exemplary embodiments with reference to the attached drawings.

### BRIEF DESCRIPTION OF THE DRAWINGS

FIG. 1A is a top view of an ink jet head 100 according to one embodiment of the present invention.

FIG. 1B is a bottom view of the ink jet head 100 according to one embodiment of the present invention.

FIG. 1C is a partial perspective view for illustrating a part of a cross-section taken along the line A-A′ illustrated in FIG. 1A and FIG. 1B.

FIG. 2A is a schematic view for illustrating a state of an ink-repellent member according to one embodiment of the present invention.

FIG. 2B is a schematic view for illustrating a state of an ink-repellent member in the related art.

FIG. 3 is a graph showing a relationship between a treatment time and a ratio of a fluorine atom amount when the ink-repellent member according to one embodiment of the present invention and the ink-repellent member in the related art are subjected to immersion treatment.

FIG. 4A is an image obtained by measuring a surface of an underlying portion having no fluorine bonded thereto in Example 1 with an atomic force microscope (AFM).

FIG. 4B is an image obtained by measuring a surface of an underlying portion of an ink-repellent member in Example 1 with the AFM.

FIG. 4C is an image obtained by measuring a surface of an underlying portion having no fluorine bonded thereto in Comparative Example 2 with the AFM.

FIG. 4D is an image obtained by measuring a surface of an underlying portion of an ink-repellent member in Comparative Example 2 with the AFM.

### DESCRIPTION OF THE EMBODIMENTS

When a fluorine-containing silane coupling agent is bonded, a silicon oxide is generally used for an underlying portion, but a tantalum oxide may be used for the purpose of exhibiting liquid resistance as in Japanese Patent Application Laid-Open No. 2014-124879.

However, it has been known that a Ta—O bond formed when a silane coupling agent is bonded to a tantalum oxide has a small covalent bonding property (large ionic bonding property) as compared to a Si—O bond formed when a silicon oxide is used for an underlying portion (“Journal of The Surface Finishing Society of Japan,” The Surface Finishing Society of Japan, 1998, Vol. 49, No. 2, pp. 191-194). In view of the foregoing, the inventors of the present invention have found that there is a problem in that reactivity between the underlying portion and the silane coupling agent is decreased, and the ability of an ink-repellent member is reduced owing to prolonged ink contact and sliding.

Thus, even when a tantalum oxide is used for an underlying portion, there has been a demand for an ink-repellent member excellent in sliding resistance and ink resistance.

An ink-repellent member, an ink jet head, and the like according to embodiments of the present invention are described below with reference to the drawings. In the following, for example, the terms “ink repellency” and “ink-repellent member” are described, but may be read as “water repellency” and “water-repellent member” assuming an aqueous ink. In addition, when the present invention is implemented, it is not necessarily required to limit the kind and application of a liquid, and hence the terms “ink repellency” and “ink-repellent member” may be read as “liquid repellency” and “liquid-repellent member” in the following description. The embodiments described below are examples, and for example, the detailed configuration may be appropriately changed and implemented by a person skilled in the art without departing from the spirit of the present invention.

In the drawings referred to in the description of the following embodiments and Examples, elements with the same reference symbols have the same functions unless otherwise stated. In addition, the description “XX or more and YY or less” or “XX to YY” representing a numerical range means a numerical range including XX (lower limit) and YY (upper limit) that are end points unless otherwise stated. When the numerical ranges are described in stages, the upper limits and lower limits of the respective numerical ranges may be arbitrarily combined.

Herein, a liquid to be handled may be described as “ink”, but the ink is not limited to a liquid for forming a character or an image. For example, the ink may be a liquid containing a functional material for forming a functional thin film, such as an electrode or an optical filter, or a functional element such as an organic EL element.

An ink-repellent member according to the present invention is an ink-repellent member including an underlying portion that contains a tantalum oxide, and has a fluorine compound bonded to a surface of the underlying portion via a Ta—O—Si bond, wherein, when a ratio of a fluorine atom amount with respect to a total of a carbon atom amount, an oxygen atom amount, the fluorine atom amount, a silicon atom amount, and a tantalum atom amount in measurement by X-ray photoelectron spectroscopy of the surface of the underlying portion (surface of the ink-repellent member) after the ink-repellent member is subjected to the following immersion treatment (1) and (2) is represented by F, the F is 50 atm % or more.

### (Immersion Treatment)

(1) A test piece including the surface of the underlying portion (surface of the ink-repellent member) is cut out of the ink-repellent member, is placed in a sealable container containing a fluorine solvent containing a hydrofluoroether having a boiling point of 60° C. or more, and is immersed in the fluorine solvent so that the test piece is entirely immersed therein.
(2) The test piece is maintained at 60° C. for 4 hours in a sealed state after the immersion in (1).

The term “ink-repellent member” as used herein refers to a member including an underlying portion having a surface to which a fluorine compound is chemically bonded (member including an underlying portion having a fluorine compound chemically bonded to a surface thereof).

The inventors of the present invention have made investigations repeatedly in order to obtain an ink-repellent member that can maintain the ink resistance and the sliding resistance for a long period of time even when a tantalum oxide is used for an underlying portion. As a result, the inventors of the present invention have found that the above-mentioned object can be achieved by subjecting a tantalum oxide to plasma treatment under an oxygen atmosphere and then bonding a fluorine compound to the tantalum oxide.

The tantalum oxide has high surface activity, and hence a hydrocarbon and the like in air easily adsorb to a surface of the tantalum oxide. Thus, in order to form a hydroxy group (hydroxyl group) that is a reactive group on the surface of the underlying portion, it has seemed preferable to treat the surface under an atmosphere of argon having a large atomic radius and high collision energy. However, as a result of the extensive investigations made by the inventors, it has been found that a hydroxy group is formed in a larger amount by performing plasma treatment under an oxygen atmosphere. Further, it has been found that the surface slope of the surface of the underlying portion after plasma treatment is performed under an oxygen atmosphere is gentle. The amount of the hydroxy group is large, and hence the bonding amount of the fluorine compound in the underlying portion is increased. In addition, the slope is gentle, and hence the fluorine compound is effectively arranged with respect to wiping without being buried in recesses on the surface. It is conceived that, with this configuration, an ink-repellent member excellent in ink resistance and sliding resistance can be achieved.

### (Ink Jet Head)

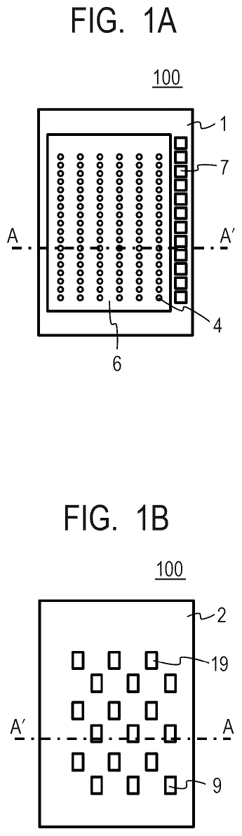

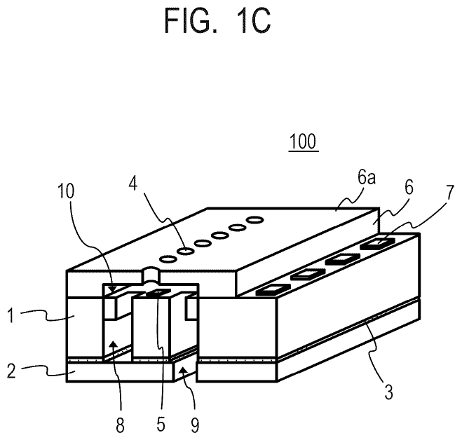

First, an ink jet head according to one embodiment of the present invention may be an ink jet head including the ink-repellent member according to the present invention. The configuration of the ink jet head according to this embodiment is described below. FIG. 1A is a top view of an ink jet head 100 according to this embodiment. FIG. 1B is a bottom view of the ink jet head 100. In addition, FIG. 1C is a partial perspective view for illustrating a part of a cross-section taken along the line A-A′ illustrated in FIG. 1A and FIG. 1B.

The ink jet head 100 may include a first flow path substrate 1 serving as a first member, a second flow path substrate 2 serving as a second member, an adhesive layer 3, ejection orifices 4, ejection energy-generating elements 5, an orifice plate 6 (ink-repellent member), electrodes 7, and an ink tank chamber. The ink tank chamber is not shown in FIG. 1A to FIG. 1C. In addition, among the constituent components of the ink jet head, components that are not directly related to the description of the present invention (e.g., an electric circuit and wiring) are not shown.

A set of the first flow path substrate 1 and the second flow path substrate 2, a set of the first flow path substrate 1 and the orifice plate 6, and a set of the second flow path substrate 2 and the ink tank chamber are each bonded to be integrated with each other via the adhesive layer 3 to form a flow path structure. In the flow path structure, a first through-flow path 8 and a second through-flow path 9 are formed and communicate to each other to form an ink supply path. In FIG. 1C, only part of the adhesive layer 3 is illustrated for the sake of convenience in illustration.

The ink is supplied from the ink tank chamber to a liquid flow path 10 through the second through-flow path 9 formed in each of the second flow path substrate 2 and the first flow path substrate 1, and is ejected from the ejection orifices 4 after being given ejection energy by the ejection energy-generating elements 5. The ink that has not been ejected from the ejection orifices 4 flows back to the ink tank chamber through the first through-flow path 8 formed in the first flow path substrate 1 and a third through-flow path 19 (circulation return path) formed in the second flow path substrate 2.

Although the plurality of ejection orifices 4 are arranged in the orifice plate 6, an arrangement method (number and position) for the ejection orifices 4 is not limited to the illustrated example. On an outer surface of the orifice plate 6, that is, an orifice surface 6a that is the surface on an opposite side to the liquid flow path 10, a fluorine compound is bonded to the surface of the underlying portion described later. On the first flow path substrate 1, the ejection energy-generating elements 5 for ejecting a liquid are arranged at positions corresponding to the respective ejection orifices 4, and the ejection energy-generating elements 5 are driven in response to an electric signal transmitted from outside via the electrodes 7. For example, electrothermal conversion elements or piezoelectric elements are suitably used as the ejection energy-generating elements 5. Silicon is suitable as a material to be used for a base material of the orifice plate 6, but silicon carbide, silicon nitride, various glasses, such as quartz glass and borosilicate glass, various ceramics, such as alumina and gallium arsenide, and resins such as polyimide may each be used as the material in addition to silicon. In this embodiment, the orifice plate is formed of the ink-repellent member, but the ink jet head itself may be formed of the ink-repellent member.

### (Underlying Portion)

An underlying portion to be arranged on, for example, the outer surface (orifice surface 6a) of the orifice plate 6 illustrated in FIG. 1A to FIG. 1C is formed so as to contain an inorganic oxide. The underlying portion has a hydroxy group formed on a surface thereof and hence can form a chemical bond with a fluorine compound having a reactive silyl group (fluorine-containing silane coupling agent). Through the formation of the chemical bond, the adhesiveness between the underlying portion and the fluorine compound can be improved. The underlying portion may be formed on the base material as an underlying film or an underlying layer. However, when the base material itself (bulk material) is formed so as to contain an inorganic oxide, the base material itself may be used as the underlying portion.

In the present invention, the underlying portion contains a tantalum oxide as the inorganic oxide. The tantalum oxide forms compounds each having a valence of from +2 to +5 as an oxidation number. Of those, tantalum pentoxide is preferred from the viewpoint of being capable of forming a hydroxy group to be a reaction site in a large amount. In addition to the tantalum oxide, the underlying portion may further contain oxide materials, such as silicon oxide, zirconia, alumina, titania, hafnia, cerium oxide, tungsten oxide, niobium oxide, and yttrium oxide.

As the underlying portion containing the tantalum oxide, for example, an underlying film may be formed on a base material (e.g., silicon) by a sputtering method, an ion-assisted vapor deposition method, an atomic layer deposition (ALD) method, or the like. Of those, the ALD method is preferably used from the viewpoint of being capable of forming a high-density film. When the density is high, the ink resistance to an alkaline ink is further improved.

When the underlying film is formed as the underlying portion on the base material, silicon is generally used as the base material of a lower layer of the underlying film. In this case, a thickness of the underlying film is preferably 10 nm or more, more preferably 50 nm or more from the viewpoint of protecting silicon from an ink. In addition, the thickness is preferably 300 nm or less, more preferably 200 nm or less from the viewpoint of suppressing the cohesive failure at the time of sliding.

### (Surface Treatment of Underlying Portion)

A method of producing an ink-repellent member according to one embodiment of the present invention may be a method of producing an ink-repellent member including an underlying portion that contains a tantalum oxide, and has a fluorine compound bonded to a surface of the underlying portion via a Ta—O—Si bond, the method including the following steps (1) and (2):
(1) subjecting the surface of the underlying portion having no fluorine compound bonded thereto to plasma treatment under an atmosphere having an oxygen concentration of 50 vol % or more; and
(2) applying a fluorine compound having a reactive silyl group represented by the following formula (1) onto the surface of the underlying portion subjected to the plasma treatment in the step (1), followed by dehydration condensation:

*—Si(Y¹)ₙ(OR)ₘ (1)

in the formula (1), “n” and “m” each represent an integer of from 0 to 3 and n+m=3 is satisfied, Y¹s each independently represent an alkyl group, a chloro group, or a bromo group, Rs each independently represent a hydrogen atom or an alkyl group, and “*” represents a bonding position in the fluorine compound.

In the present invention, the surface treatment of the underlying portion is preferably performed by plasma treatment under an oxygen atmosphere. As a result of investigations made by the inventors of the present invention, it has been found that, even when the surface of the underlying portion is treated under an atmosphere of any one of oxygen or argon, a contact angle after the treatment becomes low (e.g., a static contact angle of)<5°, but a hydroxy group can be formed in a larger amount by the treatment under an oxygen atmosphere as compared to the treatment under an argon atmosphere.

In order to investigate the mechanism, the surface after plasma treatment was measured by X-ray photoelectron spectroscopy (XPS), and a ratio of a valence of from +1 to +5 was calculated from the analysis of Ta 4f. As a result, it was recognized that a ratio of a valence of +5 was decreased in the case of the treatment under an argon atmosphere (95% before the treatment, 85% after the treatment). Meanwhile, a decrease in ratio of a valence of +5 was not recognized in the case of the treatment under an oxygen atmosphere. Thus, it is presumed that, when a tantalum oxide is subjected to plasma treatment, a hydroxy group can be formed in a large amount by the treatment under an oxygen atmosphere.

For example, when plasma treatment is performed under a mixed atmosphere of oxygen and another gas such as argon, an oxygen concentration is preferably 50 vol % or more, more preferably 75 vol % or more, still more preferably 80 vol % or more. The treatment may be performed under an atmosphere containing only oxygen (oxygen concentration is 100 vol %). When the oxygen concentration is 50 vol % or more, a hydroxy group is sufficiently formed.

In addition, a bias may be applied in order to perform the treatment by accelerating the plasma generated during the treatment. As a result, the surface treatment is accelerated, and a hydroxy group can be further formed.

The amount of the hydroxy group on the surface of the underlying portion after plasma treatment may be quantified by treating the surface of the underlying portion with a low-molecular-weight silane coupling agent containing fluorine and measuring a fluorine atom amount by X-ray photoelectron spectroscopy. In this case, the ratio of the fluorine atom amount is calculated, and the amount of the hydroxy group may be evaluated based on the calculated value in the same manner as in the evaluation of the bonding amount of the fluorine compound described later.

Further, the surface profile of the underlying portion after plasma treatment was analyzed. As a result, it was found that the arithmetic mean roughness (Ra) did not vary depending on the atmosphere, but that the surface slope (root-mean-square slope Rdq) became gentle when plasma treatment was performed under an oxygen atmosphere, as compared to the case in which the treatment was performed under an argon atmosphere. The details of the reason for this are unclear, but it is presumed that, when an active species generated under the oxygen atmosphere reacts with a tantalum oxide, the tantalum oxide is subjected to surface treatment in a uniform and soft manner to the extent that the surface is not roughened.

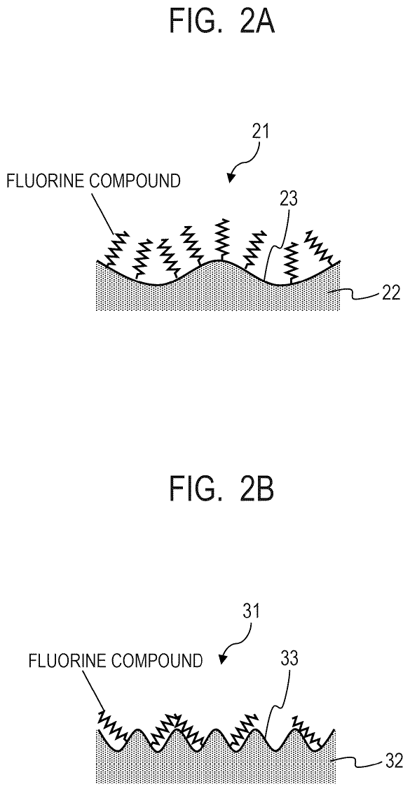

FIG. 2A is a schematic view for illustrating a state of an ink-repellent member according to one embodiment of the present invention, and FIG. 2B is a schematic view for illustrating a state of an ink-repellent member in the related art. In an ink-repellent member 21 according to this embodiment, a fluorine compound is chemically bonded to a surface 23 of an underlying portion 22. It is conceived that, in the case where the slope of the surface is gentle, when the fluorine compound is chemically bonded to the underlying portion, the fluorine compound can be bonded at positions and angles at which the fluorine compound is not buried in recesses on the surface, and as a result, it is possible to achieve a state in which the sliding resistance can be effectively exhibited with respect to wiping. Meanwhile, a fluorine compound is chemically bonded to a surface 33 of an underlying portion 32 in an ink-repellent member 31 in the related art, but the slope is steeper than that of the ink-repellent member 21, with the result that the fluorine compound is liable to be buried in recesses on the surface, and the bonding amount of the fluorine compound is also small.

The Rdq is a value obtained by evaluating the magnitude of a local slope angle and quantifying the steepness of irregularities of the surface. The Rdq may be calculated, for example, by measuring the surface with an atomic force microscope (AFM).

The ink-repellent member according to one embodiment of the present invention may be an ink-repellent member including an underlying portion that contains a tantalum oxide, and has a fluorine compound bonded to a surface of the underlying portion via a Ta—O—Si bond, wherein the surface of the underlying portion (surface of the ink-repellent member) has a root-mean-square slope (Rdq) of 0.08 or less.

The Rdq of the surface of the underlying portion having a fluorine compound bonded thereto is preferably 0.08 or less, more preferably 0.07 or less. It is preferred that the Rdq be 0.08 or less because the sliding resistance is improved.

In the case where the tantalum oxide is used as the underlying portion, when plasma treatment is performed under an oxygen atmosphere, the amount of a hydroxy group that is a reactive group can be increased, and it is possible to achieve a state in which the effect is easily exhibited without the fluorine compound being buried in recesses. Thus, an ink-repellent member excellent in ink resistance and sliding resistance can be achieved.

### (Fluorine Compound)

The fluorine compound to be used in the ink-repellent member has a linear main chain structure, and one of the ends on both sides of the main chain forms a chemical bond (Ta—O—Si) with the hydroxy group on the surface of the tantalum oxide of the underlying portion. The fluorine compound to be used in the production of the ink-repellent member in order to form the Ta—O—Si bond has at least one reactive silyl group represented by the following formula (1). When the fluorine compound has the reactive silyl group at one of its ends, a reaction between molecules of the fluorine compound can be suppressed.

*—Si(Y¹)ₙ(OR)ₘ (1)

In the formula (1), “n” and “m” each represent an integer of from 0 to 3, and n+m=3 is satisfied. For example, “m” may represent 3, and “n” may represent 0. Y¹s each independently represent an alkyl group, a chloro group, or a bromo group. Rs each independently represent a hydrogen atom or an alkyl group. It is preferred that Y¹s each represent a methyl group. When the number of carbon atoms of Y¹s is small, a decrease in reactivity caused by steric hindrance is easily suppressed. It is preferred that Rs each represent a methyl group because the hydrolysis of the fluorine compound becomes fast, and the reaction becomes fast.

In addition, the fluorine compound preferably has a perfluoromethyl structure (perfluoromethyl group) at the other end. The perfluoromethyl structure has small surface free energy and can express high ink repellency.

The main chain structure of the fluorine compound preferably has a perfluoropolyether (hereinafter sometimes referred to as “PFPE”) structure from the viewpoint of ensuring ink repellency and sliding resistance.

That is, a preferred structure of the fluorine compound to be used in the production of the ink-repellent member may be represented by the following formula (10).

F₃C—R²—R¹ (10)

In the formula (10), R¹ represents the reactive silyl group represented by the formula (1), and R² represents a structure having a perfluoropolyether structure.

The fluorine compound preferably has, as the PFPE structure, at least one of a repeating structure represented by the following formula (2), a repeating structure represented by the following formula (3), a repeating structure represented by the following formula (4), and a repeating structure represented by the following formula (5).

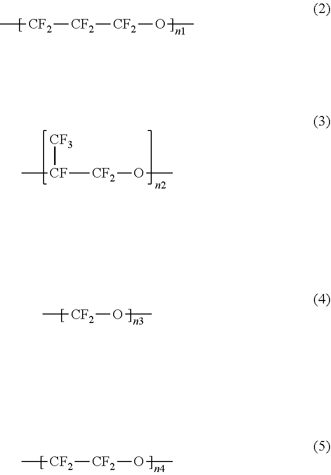

In the formulae (2), (3), (4), and (5), n1, n2, n3, and n4 each independently represent an integer of 1 or more.

Preferred specific examples of the fluorine compound include a compound represented by the following formula (6), a compound represented by the following formula (7), a compound represented by the following formula (8), and a compound represented by the following formula (9):

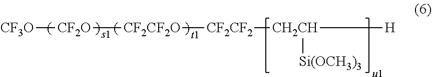

in the formula (6), s1, t1, and u1 each independently represent an integer of 1 or more;

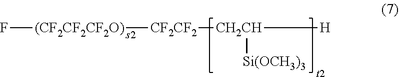

in the formula (7), s2 and t2 each independently represent an integer of 1 or more;

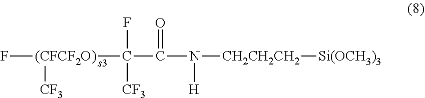

in the formula (8), s3 represents an integer of 1 or more; and

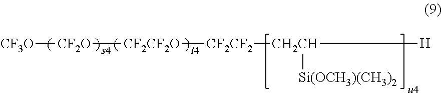

in the formula (9), s4, t4, and u4 each independently represent an integer of 1 or more.

The fluorine compound in the ink-repellent member is preferably a fluorine compound that has a main chain having a perfluoropolyether structure and has a perfluoromethyl group at its end. That is, a preferred structure of the fluorine compound in a state in which the fluorine compound is chemically bonded to the surface of the underlying portion via a Ta—O—Si bond may be represented by the following formula (11):

F₃C—R²—R³—* (11)

in the formula (11), R² represents a structure having a perfluoropolyether structure, R³ represents a Si—O bond, and the fluorine compound is chemically bonded to the surface of the underlying portion via a Ta—O—Si bond containing the Si—O bond, and “*” represents a bonding position with respect to a tantalum atom.

The number average molecular weight of the fluorine compound is preferably 4,000 or more. The number average molecular weight of the fluorine compound may be calculated, for example, by ¹⁹F-NMR measurement based on the integral ratio with respect to the perfluoromethyl group (CF₃ group) at the end.

### (Method of Producing Ink-Repellent Member)

Subsequently, a method of bonding a fluorine compound to a surface of an underlying portion containing a tantalum oxide is described. The fluorine compound may be bonded by silane coupling treatment. An example thereof is described below.

First, for example, an underlying portion that is an underlying film containing a tantalum oxide is formed on a substrate such as an orifice plate. An example of a method of forming a tantalum oxide as an underlying film is a method of forming a tantalum oxide by an atomic layer deposition (ALD) method.

Next, a hydroxy group is formed on the surface of the underlying portion by the above-mentioned plasma treatment.

Next, a fluorine compound is applied to the surface of the underlying portion having the hydroxy group formed thereon. There is no particular limitation on a method for the application, and examples thereof may include a vacuum vapor deposition method, a thermal vapor deposition method, a spray coating method, a spin coating method, and a dip coating method.

Subsequently, an alkoxysilyl group or a halogenated silyl group at the end of the fluorine compound are hydrolyzed to be converted to a silanol group (Si—OH group). Then, the silanol group of the fluorine compound and the hydroxy group formed on the underlying portion are subjected to a dehydration condensation reaction to form a Ta—O—Si bond.

Hydrolysis is caused by exposure to moisture, and is also caused by adsorbed water that exists on the surface of the underlying portion. The dehydration condensation reaction may occur also at room temperature, but may be accelerated by raising the temperature (e.g. from 100° C. to 120° C.). In particular, when the underlying portion is formed of a tantalum oxide, the covalent bonding property of a Ta—O bond of the Ta—O—Si bond is small, and the reaction is less likely to occur. Thus, in the reaction at room temperature, reaction energy required for bonding is insufficient, and the reaction between molecules of the fluorine compound (Si—O—Si bond) may be liable to occur. In order to sufficiently increase the bonding amount on the underlying portion of the fluorine compound, it is preferred that the applied fluorine compound be caused to react by heating at high temperature to accelerate the bonding between the fluorine compound and the underlying portion. Specifically, for example, it is preferred that the applied fluorine compound be heated to 100° C. or more to cause dehydration condensation.

A reaction time may be appropriately selected in accordance with the temperature, and the reaction time is, for example, about 10 hours at room temperature and about 1 hour under the condition of 120° C.

Subsequently, the underlying portion is washed so that the remaining unbonded fluorine compound was removed. There is no particular limitation on a method for the washing, but for example, it is only required that the ink-repellent member be immersed in a fluorine solvent that is compatible with the fluorine compound. The underlying portion is washed to the extent that it can be visually recognized that the fluorine compound does not remain on the underlying portion.

The thickness of the fluorine compound is preferably 5 nm or more, more preferably 10 nm or more.

After the fluorine solvent is dried, the bonding amount of the fluorine compound, ink resistance, and sliding resistance may be evaluated.

### (Bonding Amount of Fluorine Compound)

In the ink-repellent member according to one embodiment of the present invention, a ratio F of the fluorine atom amount measured as described below is 50 atm % (atomic percentage) or more. The ratio F of the fluorine atom amount corresponds to the bonding amount of the fluorine compound on the surface of the ink-repellent member. The surface of the ink-repellent member (surface of the underlying portion) after the ink-repellent member having a fluorine compound bonded thereto is subjected to the following immersion treatment (1) and (2) is measured by X-ray photoelectron spectroscopy, and the ratio F of the fluorine atom amount with respect to the total of a carbon atom amount, an oxygen atom amount, the fluorine atom amount, a silicon atom amount, and a tantalum atom amount is calculated.

### (Immersion Treatment)

(1) A test piece including the surface of the underlaying portion is cut out of the ink-repellent member, is placed in a sealable container containing a fluorine solvent containing a hydrofluoroether having a boiling point of 60° C. or more, and is immersed in the fluorine solvent so that the test piece is entirely immersed therein.
(2) The test piece is maintained at 60° C. for 4 hours in a sealed state after the immersion in (1).

XPS measurement conditions may be set as described below.
Measurement device: Quantera II (product name), manufactured by ULVAC-PHI, Incorporated
X-ray source: AlKα
Analysis region: ϕ200 μm
Pass energy: 140 eV
Number of scans: 10
Detection angle: 45°
Detection elements: C, O, F, Si, Ta
XPS peaks: C1s, O1s, F1s, Si2p, Ta4f

The hydrofluoroether is a compound formed of a carbon atom, a fluorine atom, a hydrogen atom, and an ether bond (—O—). The hydrofluoroether only dissolves the fluorine compound and has no corrosivity. Thus, through the above-mentioned treatment, the fluorine compound that has not been completely removed in the washing step, despite not being chemically bonded to the underlying portion, can be removed. That is, only the fluorine compound that has been actually chemically bonded to the underlying portion can be quantified by performing the above-mentioned immersion treatment.

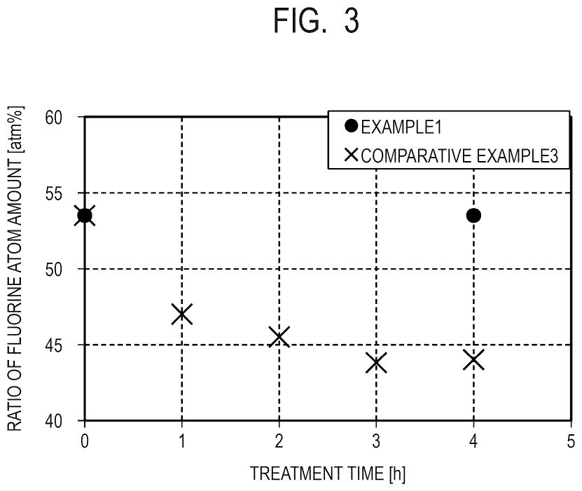

As an example, FIG. 3 shows a change in ratio of a fluorine atom amount when each of the ink-repellent member according to one embodiment of the present invention used in Example 1 described below and the ink-repellent member in the related art used in Comparative Example 3 is subjected to the above-mentioned immersion treatment. The above-mentioned ratio of the fluorine atom amount is the ratio of a fluorine atom amount with respect to the total of a carbon atom amount, an oxygen atom amount, the fluorine atom amount, a silicon atom amount, and a tantalum atom amount.

It is understood that the ratios of the fluorine atom amount after the washing step (corresponding to the treatment time of 0 hours in FIG. 3) are the same, but the ratio F of the ink-repellent member in the related art is reduced by the immersion treatment. Meanwhile, it is understood that the ink-repellent member according to this embodiment produced in Example 1 maintains the ratio F at the time of maintenance for 4 hours. The removal is completed by the treatment for 3 hours or more, and hence the evaluation may be made based on the treatment for 4 hours.

The unbonded fluorine compound may also contribute to an increase in durability, and hence, in general, the unbonded fluorine compound is actively used without being removed for practical purposes. However, the unbonded fluorine compound is diffused into an ink, for example, during the contact with the ink and is removed over time. As a result, the underlying portion having low liquid repellency is exposed, leading to deterioration of an ink-repellent function. Even when the ratios of the fluorine atom amount are the same before the above-mentioned treatment, the amount bonded to the underlying portion is actually changed by a film-forming process. Thus, an ink-repellent member excellent in ink resistance can be obtained by achieving an ink-repellent member having a large ratio F after the above-mentioned treatment.

The ratio F after the above-mentioned immersion treatment is preferably 50 atm % or more, more preferably 52 atm % or more. When the ratio F is 50 atm % or more, the ink resistance becomes sufficient.

There is no particular limitation on the fluorine solvent containing the hydrofluoroether to be used for the immersion treatment, and examples of commercially available products thereof may include Novec (trademark) 7200 (boiling point: 76° C., manufactured by 3M Company, structure: C₄F₉OC₂H₅), Sumitec Solvent 72 (boiling point: 76° C., manufactured by Sumico Lubricant Co., Ltd.), and SOLBLE RN2000 (boiling point: 76° C., manufactured by SOLVEX Co., Ltd.) (each of which contains a compound having the same structure as that of Novec 7200 as a main component). The fluorine solvent containing the hydrofluoroether may be the hydrofluoroether itself (hydrofluoroether content is 100%).

### (Method of Producing Article Including Using Ink-Repellent Member)

A method of producing an article according to one embodiment of the present invention is a method of producing an article including ejecting a liquid through use of the above-mentioned ink-repellent member (e.g., an ink jet head), wherein the liquid is an ink containing a functional material for forming a functional thin film or a functional element.

### EXAMPLES

Specific Examples and Comparative Examples are described below.

### Example 1

Tantalum pentoxide was laminated to 100 nm on a Φ3-inch silicon substrate with an ALD film-forming device.

Next, the silicon substrate having the tantalum pentoxide formed thereon as an underlying film was placed in a chamber of a plasma treatment device, and a surface of the underlying film was treated. Specifically, after the inside of the chamber was evacuated, only oxygen was introduced. Then, plasma was generated, and a bias was applied to accelerate the plasma (output power value: 120 W). This state was maintained for 300 seconds.

Subsequently, the silicon substrate in which the surface of the underlying film was treated was placed in a vacuum vapor deposition machine, and a fluorine compound was deposited from the vapor on the surface having the underlying film formed thereon. The compound having a number average molecular weight of 5,000 represented by the formula (6) was used as the fluorine compound. The vapor deposition was performed in such a manner that 160 mg of the fluorine compound in a state of being impregnated into steel wool was placed in a Cu container and the fluorine compound was heated on a resistance boat.

Subsequently, the silicon substrate having the fluorine compound deposited from the vapor thereon was placed in an oven, and was allowed to stand still for 45 minutes under an environment at 120° C.

Subsequently, the taken-out silicon substrate was washed by immersion in a fluorine solvent for 30 seconds so that the fluorine compound adhering to the surface was removed. The washing was repeated twice through use of a fresh fluorine solvent, and the solvent was dried. Thus, an ink-repellent member having the fluorine compound bonded thereto was obtained.

### Examples 2 to 5 and Comparative Examples 1 to 3

An ink-repellent member according to each of Examples and Comparative Examples was produced by the same method as that in Example 1 except that the conditions for the plasma treatment of the underlying film and the dehydration condensation were changed to conditions shown in Table 1-1 and Table 1-2.

Methods of evaluating the underlying portion and the ink-repellent member according to each of Examples and Comparative Examples are described below.

### (Evaluation 1: Amount of Hydroxy Group on Underlying Portion)

A test piece (thickness: about 700 μm, size: about 2 cm on each side) including an underlying portion of tantalum pentoxide (having no fluorine compound bonded thereto) subjected to plasma treatment was cut out, and a vial bottle containing (3,3,3-trifluoropropyl)dimethylchlorosilane (manufactured by Gelest Inc.) was placed in a PFA container. The test piece was immersed in (3,3,3-trifluoropropyl)dimethylchlorosilane. The container was sealed with a lid, and was allowed to stand still at 30° C. for 20 hours. The amount of a hydroxy group was evaluated by: measuring the surface of the underlying portion in the taken-out test piece by X-ray photoelectron spectroscopy (XPS); and calculating the ratio of a fluorine atom amount with respect to the total of a carbon atom amount, an oxygen atom amount, the fluorine atom amount, a silicon atom amount, and a tantalum atom amount.

### XPS Measurement Conditions

Measurement device: Quantera II (product name), manufactured by ULVAC-PHI, Incorporated
X-ray source: AlKα
Analysis region: ϕ200 μm
Pass energy: 140 eV
Number of scans: 10
Detection angle: 45°
Detection elements: C, O, F, Si, Ta
XPS peaks: C1s, O1s, F1s, Si2p, Ta4f

The amount of the hydroxy group was evaluated based on the following criteria.
A: The ratio of the fluorine atom amount is 5.0 atm % or more.
B: The ratio of the fluorine atom amount is 4.0 atm % or more and less than 5.0 atm %.
C: The ratio of the fluorine atom amount is 3.0 atm % or more and less than 4.0 atm %.
D: The ratio of the fluorine atom amount is 2.0 atm % or more and less than 3.0 atm %.
E: The ratio of fluorine atom amount is less than 2.0 atm %.

When the amount of the hydroxy group on the surface of the underlying portion having no fluorine compound bonded thereto in Example 1 was evaluated, the ratio of the fluorine atom amount was 5.2 atm % to be evaluated as A.

### (Evaluation 2: Surface Profiles (Arithmetic Mean Roughness Ra and Root-Mean-Square Slope Rdq) of Underlying Portion Having No Fluorine Compound Bonded Thereto and Underlying Portion of Ink-Repellent Member)

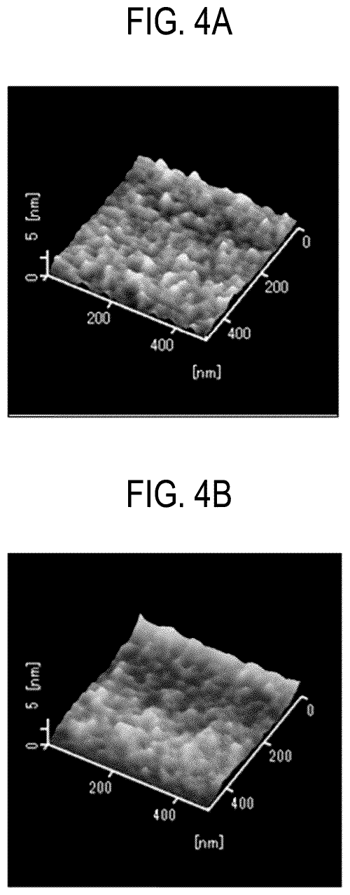

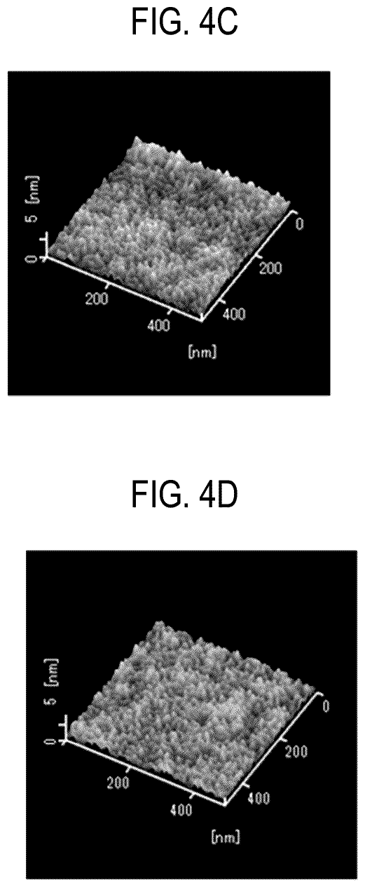

The surface profile of each of the surface of the underlying portion (having no fluorine compound bonded thereto) after plasma treatment and the surface of the underlying portion of the ink-repellent member having a fluorine compound bonded thereto was measured with an atomic force microscope (L-Trace II, manufactured by Hitachi High-Tech Science Corporation). SI-DF40 (manufactured by Hitachi High-Tech Science Corporation) was used as a cantilever, and measurement was performed in a tapping mode. As shown in FIG. 4A, FIG. 4B, FIG. 4C, and FIG. 4D, there was measured the value of a height Z (x, y) at each of positions obtained by dividing an arbitrary measurement region measuring 500 nm by 500 nm into 256 pieces on the surface of a substrate in the x-direction and the y-direction, respectively.

The Ra and the Rdq were calculated based on the methods specified in JIS B0601.

The calculation method for the Rdq is specifically described below. In the Z (x, y), a local slope dZx,y/dx in the x-direction at certain coordinates (x, y) may be represented as described below through use of the seven-point formula.

$$\frac{d {Z}_{x , y}}{d x} = \frac{{Z}_{x + 3} - 9 {Z}_{x + 2} + 45 {Z}_{x + 1} - 45 {Z}_{x - 1} + 9 {Z}_{x - 2} - {Z}_{x - 3}}{60 x}$$

In this case, when the numbers of data in the x-direction and the y-direction are represented by X and Y, respectively, care should be taken that the values at x=1, 2, 3, X−2, X−1, and X cannot be calculated because of the use of the seven-point formula. From the foregoing, the root-mean-square slope Rdq in the measurement region may be determined from the following equation.

$$R dq = \sqrt{\frac{1}{( X - 6 ) Y} {\sum }_{y = 1}^{Y} {\sum }_{x = 4}^{X - 3} {( \frac{d {Z}_{x , y}}{d x} )}^{2}}$$

The Rdq of the surface of the underlying portion of tantalum pentoxide (having no fluorine compound bonded thereto) after plasma treatment in Example 1 was measured to be Rdq=0.055. In addition, in Example 1, the Rdq of the surface of the underlying portion of the ink-repellent member having a fluorine compound bonded thereto was 0.055, which was not different from that of the surface of the underlying portion before the fluorine compound was bonded. FIG. 4A is an image showing a state at the time of the measurement of the surface of the underlying portion (having no fluorine compound bonded thereto) after plasma treatment in Example 1 with the AFM. FIG. 4B is an image showing a state at the time of the measurement of the surface of the underlying portion of the ink-repellent member having a fluorine compound bonded thereto in Example 1 with the AFM. FIG. 4C is an image showing a state at the time of the measurement of the surface of the underlying portion (having no fluorine compound bonded thereto) after plasma treatment in Comparative Example 2 with the AFM. FIG. 4D is an image showing a state at the time of the measurement of the surface of the underlying portion of the ink-repellent member having a fluorine compound bonded thereto in Comparative Example 2 with the AFM.

(Evaluation 3: Ratio of Fluorine Atom Amount Before Immersion Treatment and Bonding Amount of Fluorine Compound after Immersion Treatment)

Regarding a surface of an underlying portion of an ink-repellent member having a fluorine compound bonded thereto before the following immersion treatment, the ratio of a fluorine atom amount (ratio of a fluorine atom amount with respect to the total of a carbon atom amount, an oxygen atom amount, the fluorine atom amount, a silicon atom amount, and a tantalum atom amount) was measured by X-ray photoelectron spectroscopy. In addition, regarding the surface of the underlying portion of the ink-repellent member after the following immersion treatment was performed, the ratio F (ratio of a fluorine atom amount with respect to the total of a carbon atom amount, an oxygen atom amount, the fluorine atom amount, a silicon atom amount, and a tantalum atom amount) was measured, and the bonding amount of the fluorine compound was evaluated. In Example 1, the ratio of the fluorine atom amount on the surface side of the ink-repellent member before the immersion treatment was 53.5 atm %. In addition, in Example 1, the ratio F of the fluorine atom amount on the surface side of the ink-repellent member after the following immersion treatment was performed was 53.5 atm %.

### (Immersion Treatment)

(1) A test piece (thickness: about 700 μm, area: about 2 cm on each side) including a surface of an underlying portion of an ink-repellent member having a fluorine compound bonded thereto is placed in a sealable container containing a hydrofluoroether having a boiling point of 60° C. or more (Novec 7200, boiling point: 76° C., manufactured by 3M Company), and is immersed in the hydrofluoroether so that the test piece is entirely immersed therein.
(2) The test piece is maintained at 60° C. for 4 hours in a sealed state.

### XPS Measurement Conditions

Measurement device: Quantera II (product name), manufactured by ULVAC-PHI, Incorporated
X-ray source: AlKα
Analysis region: ϕ200 μm
Pass energy: 140 e V
Number of scans: 10
Detection angle: 45°
Detection elements: C, O, F, Si, Ta
XPS peaks: C1s, O1s, F1s, Si2p, Ta4f

### (Evaluation 4: Evaluation of Ink Resistance)

The ink resistance of an ink-repellent member having a fluorine compound bonded thereto is evaluated by the following procedure. An alkali dye ink (BCI-7C, manufactured by Canon Inc.) was used as an ink. The ink is placed in a PFA container. The ink-repellent member is immersed in the ink so that the entire surface thereof is brought into contact with the ink, and the container is sealed with a lid. The container is placed in an oven in this state, and the temperature of 60° C. is maintained for 30 weeks. The taken-out ink-repellent member was thoroughly washed with water so that the ink was removed. Then, a receding contact angle was measured and evaluated by the following method.

A contact angle meter (product name: DM-701, manufactured by Kyowa Interface Science Co., Ltd., analysis software: FAMAS (ver. 3.5.5)) was used. Conditions for the measurement were as described below.
Droplets: 2 μL (pure water)
Receding contact angle: the angle was calculated by a sessile drop method.

The receding contact angle was measured specifically by the following method. The contact angle was measured at 80 points at intervals of 15 seconds after the landing of a droplet. The following calculation was performed in the order from a time of 0 seconds through use of the values of the contact angle and the contact radius (unit: μm) at a certain time calculated from the above-mentioned software, and the following processes (A) and (B) were performed.
(A) When the value of a contact radius at a time “t” is represented by Rₜ and the value of a contact radius after t+90 seconds is represented by Rₜ₊₉₀, the value “x” of (Rₜ−Rₜ₊₉₀)² was calculated.
(B) When the value “x” was 200 or less, the process (A) was performed again, and the contact angle at a time “t” when the value “x” first exceeded 200 was defined as the receding contact angle.
A: The receding contact angle is 100° or more.
B: The receding contact angle is 95° or more and less than 100°.
C: The receding contact angle is 90° or more and less than 95°.
D: The receding contact angle is 85° or more and less than 90°.
E: The receding contact angle is less than 85°.

### (Evaluation 5: Evaluation of Sliding Resistance)

The sliding resistance of an ink-repellent member having a fluorine compound bonded thereto is evaluated by the following procedure. A high-density felt material (CS-7, manufactured by Taber Industries) is attached to a friction and wear tester (FPR-2100, manufactured by Rhesca Co., Ltd.) as a sliding material, and a reciprocating sliding test is performed on the surface of the ink-repellent member. The reciprocating sliding test is performed under the conditions of a sliding load of 650 g, a sliding width of 10 mm, a linear velocity of 50.8 mm/sec, and the number of sliding cycles of 15,000. The receding contact angle of the surface of the ink-repellent member after sliding was measured and evaluated by the method described in Evaluation 4.

The specifications of the underlying films and the ink-repellent members according to Examples 1 to 5 and Comparative Examples 1 to 3, and the evaluation results of Evaluation 1, Evaluation 2, and Evaluation 3 are collectively shown in Table 1 below. A static contact angle of the surface of the underlying portion having no fluorine bonded thereto after plasma treatment was measured under the same conditions (liquid droplets) with the same equipment as those used in Evaluation 4, and the contact angle one second after the landing of a droplet was defined as the static contact angle.

TABLE 1

| | Underlying portion (ALD-tantalum pentoxide having no fluorine | | | | | |
|---|---|---|---|---|---|---|
| | compound bonded thereto) | | | | | |
| | Plasma treatment | | | | | |
| | conditions | | | | | |
| | | Power | Surface chemical | | Surface profile | |
| | | value at | state | | Arithmetic | Root- |
| | | time of | Static | | mean | mean- |
| | | application | contact | Amount | roughness | square |
| | Atmosphere | of bias | angle | of OH | (Ra) | slope |
| | [vol %] | [W] | [°] | group | [nm] | (Rdq) |
| Example 1 | O₂/Ar = 100/0 | 120 | <5 | A | 6.5 | 0.055 |
| Example 2 | O₂/Ar = 100/0 | 0 | <5 | B | 6.5 | 0.065 |
| Example 3 | O₂/Ar = 100/0 | 120 | <5 | A | 6.5 | 0.055 |
| Example 4 | O₂/Ar = 100/0 | 0 | <5 | B | 6.5 | 0.065 |
| Example 5 | O₂/Ar = 75/25 | 120 | <5 | C | 6.5 | 0.075 |
| Comparative | O₂/Ar = 25/75 | 120 | <5 | D | 6.4 | 0.085 |
| Example 1 | | | | | | |
| Comparative | O₂/Ar = 0/100 | 120 | <5 | E | 6.4 | 0.100 |
| Example 2 | | | | | | |
| Comparative | O₂/Ar = 0/100 | 120 | <5 | E | 6.4 | 0.100 |
| Example 3 | | | | | | |

| | | | Underlying portion (ink-repellent member) | | |
|---|---|---|---|---|---|
| | | | | Ratio of fluorine atom amount | |
| | Dehydration | | | [atm %] | |
| | condensation | | Root-mean- | Before | Bonding amount |
| | Temperature | Time | square slope | immersion | after immersion |
| | [° C.] | [h] | (Rdq) | treatment | treatment (F) |
| Example 1 | 120 | 0.75 | 0.055 | 53.5 | 53.5 |
| Example 2 | 120 | 0.75 | 0.065 | 53.5 | 52.5 |
| Example 3 | 23 | 10 | 0.055 | 53.5 | 51.0 |
| Example 4 | 23 | 10 | 0.065 | 53.5 | 50.5 |
| Example 5 | 120 | 0.75 | 0.075 | 53.5 | 50.0 |
| Comparative | 120 | 0.75 | 0.085 | 53.5 | 49.0 |
| Example 1 | | | | | |
| Comparative | 120 | 0.75 | 0.100 | 53.5 | 46.5 |
| Example 2 | | | | | |
| Comparative | 23 | 10 | 0.100 | 53.5 | 44.0 |
| Example 3 | | | | | |

The results of Evaluation 4 and Evaluation 5 of the ink-repellent films according to Examples 1 to 5 and Comparative Examples 1 to 3 are collectively shown in Table 2 below.

TABLE 2

| | Ink resistance | Sliding resistance |
|---|---|---|
| Example 1 | A | A |
| Example 2 | A | A |
| Example 3 | B | A |
| Example 4 | B | B |
| Example 5 | C | C |
| Comparative Example 1 | D | D |
| Comparative Example 2 | D | E |
| Comparative Example 3 | E | E |

In order to satisfy practicality as an ink-repellent member, the contact angle is required to be 90° or more. Thus, it can be said that the ink-repellent members according to Examples 1 to 5, which are evaluated to be A to C for both ink resistance and sliding resistance, have more excellent practical characteristics than those of the ink-repellent members according to Comparative Examples 1 to 3.

According to the present invention, an ink-repellent member and an ink jet head excellent in both sliding resistance and ink resistance can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-221727, filed Dec. 27, 2023, which is hereby incorporated by reference herein in its entirety.

What is claimed is:

1. An ink-repellent member comprising an underlying portion that contains a tantalum oxide, and has a fluorine compound bonded to a surface of the underlying portion via a Ta—O—Si bond,
wherein, when a ratio of a fluorine atom amount with respect to a total of a carbon atom amount, an oxygen atom amount, the fluorine atom amount, a silicon atom amount, and a tantalum atom amount in measurement by X-ray photoelectron spectroscopy of the surface after the ink-repellent member is subjected to the following immersion treatment (1) and (2) is represented by F, the F is 50 atm % or more:
(Immersion Treatment)
(1) a test piece including the surface is cut out of the ink-repellent member, is placed in a sealable container containing a fluorine solvent containing a hydrofluoroether having a boiling point of 60° C. or more, and is immersed in the fluorine solvent so that the test piece is entirely immersed therein; and
(2) the test piece is maintained at 60° C. for 4 hours in a sealed state after the immersion in (1).

2. The ink-repellent member according to claim 1, wherein the surface has a root-mean-square slope (Rdq) of 0.08 or less.

3. The ink-repellent member according to claim 1, wherein the fluorine compound has a main chain having a perfluoropolyether structure and has a perfluoromethyl group at an end thereof.

4. The ink-repellent member according to claim 1, wherein the fluorine compound has at least one of a structure represented by the following formula (2), a structure represented by the following formula (3), a structure represented by the following formula (4), and a structure represented by the following formula (5): 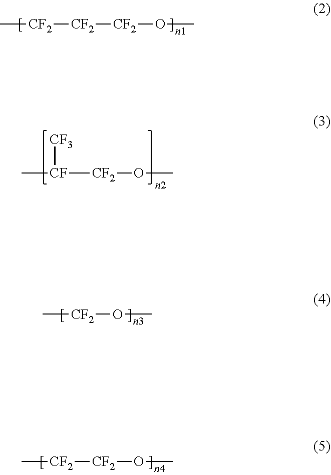
in the formulae (2), (3), (4), and (5), n1, n2, n3, and n4 each independently represent an integer of 1 or more.

5. The ink-repellent member according to claim 1, wherein the fluorine compound has a number average molecular weight of 4,000 or more.

6. The ink-repellent member according to claim 1, further comprising a base material, wherein the underlying portion is arranged on the base material.

7. An ink-repellent member comprising an underlying portion that contains a tantalum oxide, and has a fluorine compound bonded to a surface of the underlying portion via a Ta—O—Si bond,
wherein the surface has a root-mean-square slope (Rdq) of 0.08 or less.

8. The ink-repellent member according to claim 7, wherein the fluorine compound has a main chain having a perfluoropolyether structure and has a perfluoromethyl group at an end thereof.

9. The ink-repellent member according to claim 7, wherein the fluorine compound has at least one of a structure represented by the following formula (2), a structure represented by the following formula (3), a structure represented by the following formula (4), and a structure represented by the following formula (5): 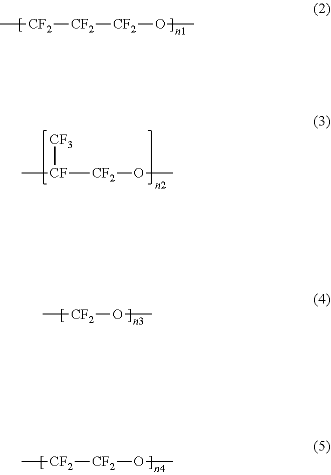
in the formulae (2), (3), (4), and (5), n1, n2, n3, and n4 each independently represent an integer of 1 or more.

10. The ink-repellent member according to claim 7, wherein the fluorine compound has a number average molecular weight of 4,000 or more.

11. The ink-repellent member according to claim 7, further comprising a base material, wherein the underlying portion is arranged on the base material.

12. A method of producing an ink-repellent member including an underlying portion that contains a tantalum oxide, and has a fluorine compound bonded to a surface of the underlying portion via a Ta—O—Si bond, the method comprising the following steps (1) and (2):
(1) subjecting the surface of the underlying portion to plasma treatment under an atmosphere having an oxygen concentration of 50 vol % or more; and
(2) applying a fluorine compound having a reactive silyl group represented by the following formula (1) onto the surface of the underlying portion subjected to the plasma treatment in the step (1), followed by dehydration condensation:
*—Si(Y¹)ₙ(OR)ₘ (1)
in the formula (1), “n” and “m” each represent an integer of from 0 to 3 and n+m=3 is satisfied, Y¹s each independently represent an alkyl group, a chloro group, or a bromo group, Rs each independently represent a hydrogen atom or an alkyl group, and “*” represents a bonding position in the fluorine compound.

13. The method of producing an ink-repellent member according to claim 12, wherein, in the step (2), the applied fluorine compound is heated to 100° C. or more to be subjected to the dehydration condensation.

14. The method of producing an ink-repellent member according to claim 12, wherein, in the step (1), the oxygen concentration is 75 vol % or more.

15. An ink jet head comprising the ink-repellent member of claim 1.

16. An ink jet head comprising the ink-repellent member of claim 7.

17. A method of producing an article comprising ejecting a liquid through use of the ink jet head of claim 15,
wherein the liquid is an ink containing a functional material for forming a functional thin film or a functional element.

18. A method of producing an article comprising ejecting a liquid through use of the ink jet head of claim 16,
wherein the liquid is an ink containing a functional material for forming a functional thin film or a functional element.
